(19) United States
(12) Patent Application Publication
(10) Pub. No.: US 2004/0183220 A1
(43) Pub. Date: Sep. 23, 2004

(54) Ultra thin layer coating using self-assembled molecules as a separating layer for diffraction grating application

(76) Inventor: Avinash Dalmia, Hamden, CT (US)

Correspondence Address: ST. ONGE STEWARD JOHNSTON & REENS, LLC, 986 BEDFORD STREET, STAMFORD, CT, 06905-5619, US

(21) Appl. No.: 10/390,810

(22) Filed: Mar. 18, 2003

(51) Int. Cl. B29D 11/00

(52) U.S. Cl. 264/2.5

(57) ABSTRACT

A method of forming a replica of a diffraction grating from a master grating is disclosed, wherein the method includes the steps of: depositing a release layer including a self-assembled monolayer (SAM) on an upper surface of the master diffraction grating; depositing a reflective layer (e.g., aluminum) over the release layer; providing an adhesive layer (e.g., epoxy) and a glass substrate over the reflective layer; and, separating the substrate, the adhesive layer, and the reflective layer from the master diffraction grating, thereby producing a replica of diffraction grating. The SAM release layer may be durable and a plurality of diffraction grating replicas may be produced from a master grating.

### FIELD OF THE INVENTION

The present invention relates generally to diffraction gratings, and more particularly to a method of producing diffraction grating replicas utilizing monolayer, preferably a self-assembled monolayer, as a release layer in the replication process.

### BACKGROUND OF THE INVENTION

Diffraction gratings are optical elements that include a precise pattern of microscopic periodic structures superimposed therein. Two types of diffraction gratings (i.e., reflection gratings and transmission gratings) are known in the art. They typically include a pattern of corrugated surface grooves. Gratings used to disperse ultraviolet (UV) and visible light usually contain between 300 and 3000 grooves per millimeter, so the distance between adjacent grooves is on the order of one micron. Diffraction gratings may be either ruled or holographic. Ruled diffraction gratings are produced by physically forming grooves into a reflective surface with a diamond mounted on a ruling engine. The distance between adjacent grooves and the angle the grooves form with respect to the substrate influence both the dispersion and efficiency of a grating. Diffraction gratings can be ruled on a variety of substrates, for example, glass, metal and ceramic.

Several diffraction gratings and methods of making diffraction gratings are disclosed, for example, in U.S. Pat. Nos. 5,080,465; 5,436,764; and 5,999,318, the contents of which are incorporated herein by reference. Typically, a master diffraction grating is first manufactured. This master grating is then used to produce many replica gratings. Each of these replica gratings may then be used as a master grating for forming other replica gratings. Thus, compared to the master gratings, the replicas may be made inexpensively.

As described in the '465 patent, a master grating may be formed by depositing aluminum over a substrate, such as glass. A diamond tool under interferometric control may then be used to rule very closely spaced grooves in the aluminum layer. The separation of the grooves is related to the wavelength of the light to be reflected by the grating and to the narrowness of the range of wavelengths it is required to reflect. In one embodiment, the diamond tool rules on the order of tens of thousands of grooves per inch. The diffraction grating surface may be ten square inches and the grating one inch thick. Creating a precision master grating by physical ruling is, therefore, an extremely time consuming and expensive process.

After a master grating has been made, typical replica gratings are made by the following process. A release agent, such as low vapor pressure oil (for example, silicone oil), silver, gold, copper glycerin, carnauba wax, or debutyphthalate, is coated on the surface of the master. This is preferably done in a vacuum chamber.

For making reflection type replica gratings, a thin (e.g., 1 micron) reflective layer, such as aluminum, is then sputtered or evaporated onto the release layer. The master grating is then removed from the vacuum chamber. Adhesive layer such as epoxy, typically liquid epoxy known in the art, is then deposited on the reflective layer, and a glass substrate is then placed on top of the epoxy. After the epoxy is cured, the glass layer, epoxy layer, and aluminum layer are then lifted from the master grating, resulting in a replica of the master grating.

In case of making transmission replica gratings, after a release agent is applied on the master as discussed above, a thin layer of MgF₂ is typically deposited onto the release agent of the master grating. Then, UV cured cement (Norland 61) is coated thereon, followed by curing of the cement and separation of the replica from the master in a similar manner as mentioned above.

However, the aforesaid method for producing replicas using conventional release agents discussed herein-above involves several conceivable disadvantages. For example, the thickness of the layer of the release agent is normally over 10 nm in order to provide adequate separation of the replica from the master grating. The relatively high thickness of such layer limits the quality and resolution of diffraction grating replicas. Moreover, layering of such release agents involves a complicated and expensive process using expensive equipment such as a vacuum chamber, and increase the manufacturing cost. Moreover, these release layers cannot be used for multiple replications since such layers are ruptured during the subsequent separation process. Also, the release layer might be retained on the replica and might need further steps for removal, thus, making the process much longer and more expensive.

### SUMMARY OF THE INVENTION

Accordingly, the present invention is directed to a new replication method for producing diffraction gratings in which self-assembled monolayer (SAM) or SAM like molecules are used as a release layer for the replication of diffraction gratings.

Applicants have discovered that self-assembled monolayer (SAM) molecules can be an ideal candidate for a release layer for replication process to produce diffraction gratings.

SAMs have been subjected to the scientific research and development for years. Such monolayers are typically formed of molecules each having a functional group (i.e., head group) that selectively attaches to a particular surface of a material, while the remainder of each molecule interacting with neighboring molecules to form a generally ordered array. SAMs may be formed on a variety of materials including metals, aluminum oxides, silicone dioxides, etc. SAMs can be an ideal candidate for changing the surface adhesion properties of the substrate. The appropriate molecules selected to apply onto aluminum oxides by the present invention are alkane phosphonic acids, alkyl silane, fluoro alkyl silane, and alkane carboxylic acids. Head molecules of these have a high affinity for the aluminum oxide layer of the master. For example, octadecyltrichlorosilane has silane group which has a high affinity for the aluminum oxide. Therefore, these molecules will easily attach to the aluminum layer of the master, and will form a compact layer thereon. Tail molecules of these have, for example, methyl group which is hydrophobic with a very low affinity for aluminum (and also for Norland 61), thus facilitating separation of the replica from the master.

The SAM layer formed on the master is substantially uniform and thin having a thickness lower than 5 nanometer (nm), which is much thinner than the conventional release agents described above. This uniform and thin layer, together with the property of good adhesion for master and poor adhesion for replica surface, makes an ideal release layer which is more advantageous over the conventional release agents. For example, utilizing the monolayer of the invention, it will improve the quality of the diffraction gratings made thereby due to its lower thickness. It will ease or simplify the separation process due to its lower affinity for replica surface. The process of putting this release layer is much simpler and cheaper as compared to the conventional processes. These layers are quite stable and will not be ruptured during a subsequent separation process and therefore can be used for multiple replication procedures, thus resulting in further reduction of the manufacturing cost.

In accordance with one preferred embodiment of the invention, a method of forming a replica of a diffraction grating from a master grating is disclosed, the method comprising the steps of: (a) depositing a release layer including self-assembled monolayer on an upper surface of the master grating; (b) depositing a reflective layer over the release layer; (c) providing an adhesive layer and a substrate over the reflective layer; and, (d) separating the substrate, the adhesive layer, and the reflective layer from the master grating. The method may further include the step of cleaning the master grating prior to the depositing of the release layer.

In accordance with another preferred embodiment of the invention, a method of providing a plurality of diffraction grating replicas from a master grating is disclosed, the method comprising the steps of: (a) providing a master grating having an aluminum layer at an outer surface; (b) depositing a release layer including self-assembled monolayer on the aluminum layer of the master grating; (c) depositing a reflective layer over the release layer; (d) providing an adhesive layer and a substrate over the reflective layer; (e) separating the substrate, the adhesive layer, and the reflective layer from the master grating; and, (f) repeating the above-identified steps (c), (d) and (e) and thereby providing a plurality of diffraction grating replicas using the master grating.

Other aspects, objects and features of the invention in addition to those mentioned above will be pointed out or will be understood from the following detailed description provided in conjunction with the accompanying drawings.

### BRIEF DESCRIPTION OF THE DRAWINGS

FIG. 1 is a flow chart illustrating the overall process of producing diffraction grating replicas in accordance with the principles and concepts of the invention.

FIG. 2 is a schematic view illustrating the basic structure of a SAM molecule of the present invention.

FIG. 3 is a schematic view illustrating assembled state of SAM molecules on the substrate in accordance with the principles and concepts of the invention.

### DETAILED DESCRIPTION OF THE DRAWINGS

While the present invention is described herein with reference to drawings and examples for particular applications, it should be understood that the present invention is not limited thereto. Those having ordinary skill in the art and access to the teachings provided herein will recognize additional modifications, applications, and embodiments within the scope thereof and additional fields in which the invention would be of significant utility without undue experimentation.

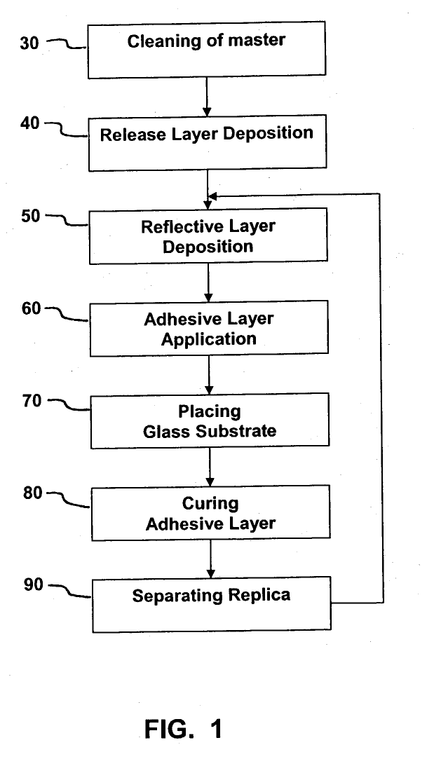

With reference to FIG. 1, the inventive methods of producing diffraction grating replicas are described herein. As a first step, the surface of a master is preferably subject to a cleaning process (block 30). The purpose of the cleaning process is to have a clean master surface free of any dirt and organic residues. Examples of this process will be later described in detail. However, other commercially available cleaning process can also be applied.

With reference to FIG. 1, release layer is then deposited on the upper surface of the master grating which typically includes an aluminum layer with a plurality of fine grooves thereon (block 40). Release layer of the present invention comprises SAM or SAM like molecules therein. Such SAM molecules are selected to have the properties of easy adhesion to the aluminum substrate of the master, also forming a compact layer of hydrophobic surface which facilitate relative easy separation from the master grating.

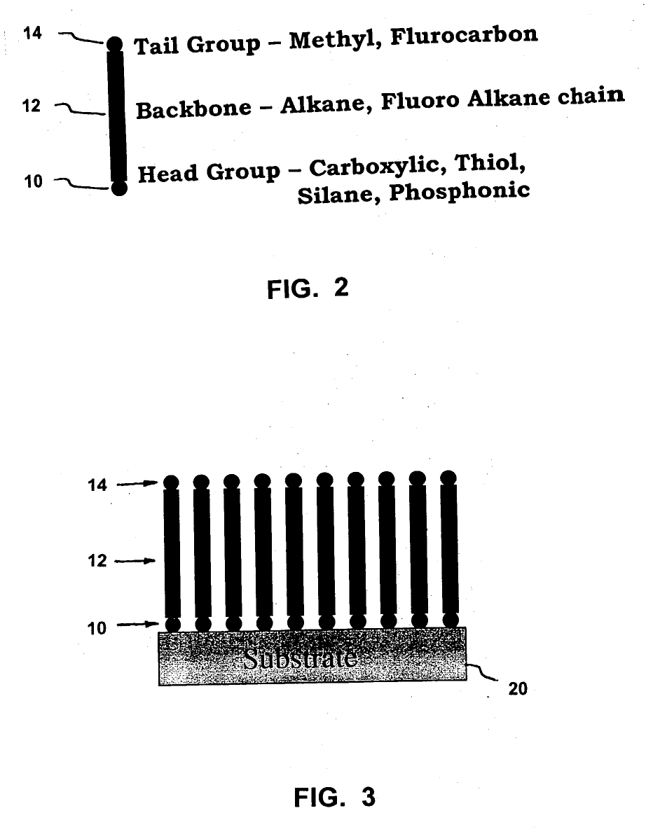

As schematically illustrated in FIGS. 2 and 3, SAM molecules consist of head group 10, intermediate group 12 (i.e., a backbone or chain structure), and tail group 14. According to the present invention, head molecules are selected to have a high affinity for substrate 20 (such as aluminum), and tail molecules are selected to modify the surface adhesion properties of the substrate. The molecules selected to attach onto aluminum substrate (including native aluminum oxides thereon) are alkane phosphonic acids, alkyl silane, fluoro alkyl silane, and alkane carboxylic acids. Head molecules of these have very high affinity for the aluminum oxide layer of the master. For example, octadecyltrichlorosilane has silane group which has a high affinity for the aluminum oxide. Therefore, these molecules will easily attach to the aluminum layer of the master, and will form a compact layer thereon. Tail molecules of these have, for example, methyl group which is hydrophobic with very low affinity for aluminum (and also for Norland 61), thus facilitating separation of the replica from the master. Schematic drawings of self-assembled monolayer (SAM) molecule and its assembly on the substrate is respectively given in FIGS. 2 and 3.

These SAM molecules have a thickness less than 5 nm, preferably in the range of about 0.5-3 nm. They can be deposited on the substrate easily, for example, by soaking it in solutions of these molecules with a suitable solvent for a few hours followed by rinsing it in pure solvent for 3-5 times. In another example, the master can be coated with solution of SAM and dried at room temperature to form a thin layer on the master.

Alkyl trichlorosilanes can also be used as alternative molecules and in this case, it is preferable but not necessary to first deposit thin layer of SiO₂ on the aluminum master prior to the deposition of the molecules.

Now, with reference to FIG. 1, a reflective layer is now deposited over the release layer (block 50). For producing reflective grating replicas, a thin layer (e.g., 1 micron) of aluminum is deposited typically under vacuum with sputtering or evaporation, or by any other commercially available methods of thin film deposition. In case of making transmission gratings, a thin layer of MgF₂ is typically deposited onto the release layer of the master grating.

Adhesive layer such as liquid epoxy or UV curable cement (e.g., Norland 61) is applied in a manner known in the art (block 60). A substrate typically made of glass is then placed on the adhesive layer (block 70), followed by curing of such curable adhesives by a method known in the art (block 80).

After curing of the adhesive layer, a replica consisting essentially of the glass substrate, adhesive layer, and reflective layer is finally separated from the master with SAMs coated thereto (block 90). Various methods are available for this process, including but not limited to the following methods. One preferred method is based on wedging the two apart, for example, with a knife or razor blade, applied perpendicularly to the grating grooves at the separation line. This task may be aided by giving both master and replica matching bevels. Another method uses specially designed tooling to carefully force the replica apart. A third method uses thermal gradients to bend the gratings apart. For this, one blank is warmed, and if necessary the second one may be cooled. However, this method does not function well when both blanks are made of low expansion materials.

SAM coating on the master applied in accordance with the disclosure is quite durable and will survive without rupturing the subsequent separation process as described above. Thus, multiple diffraction grating replicas may be produced repeating the steps from the reflective layer deposition step (block 50) to the separation step (block 90), utilizing a master grating with a SAM layer deposited thereon.

The function and aspects of the present invention will be more fully understood from the following examples of the cleaning process and release layer deposition process. The examples are intended to further describe the invention as only exemplary models, but do not intend to limit the scope of the invention.

### EXAMPLES (CLEANING OF MASTER)

The purpose of the cleaning process is to have a clean master surface free of any dirt and organic residues. Some methods described herein-below will etch the surface and can be undesirable in case of patterned surfaces.

Method 1: The aluminum coated (e.g., with about 1 micron thickness) substrate was cleaned with oxygen plasma in 30 seconds.

Method 2: The evaporated aluminum substrate was cleaned using an ungettered argon plasma sputter etch. The power used was 566 mW/cm2. The argon gas pressure was 4 mm Hg and etch time was 5 min.

Method 3: The aluminum substrate was cleaned by etching in 1.5 M NaOH at 50° C. for 10 min., and rinsed with water, and then cleaned in 10% HNO₃ for 1 min. and rinsed with water. Then, immersed in ethanol to remove water and followed by chloroform. The chloroform was removed by dry air. This method might be avoided where the surface is a patterned surface since it etches the surface.

Method 4: The aluminum substrate was cleaned in Piranha solution (e.g., 7:3v/v mixture of 98% H₂SO₄ and 30% H₂O₂) for 10 min. and followed by rinsing in deionized water and dried by spinning.

Method 5: The aluminum substrate was cleaned by sonicating in chloroform and treated in air plasma.

Method 6: The silicon substrate was cleaned by sonicating in chloroform and treated in air plasma.

Method 7: The substrate was cleaned by washing in 0.1 M KOH for 2 min. followed by washing in 0.1 M HNO₃ for 5 min., and then rinsing in deionized water and blown dry.

### EXAMPLES (DEPOSITION OF SAM LAYER)

Method A: The pretreatment solution was a 0.1 M solution of octadecyltrichlorosilanes in 90% hexadecane/10% chloroform. The solvents used in pretreatment solutions can be purified by using a column of basic alumina (such as that can be purchased from Aldrich) to remove polar impurities but can be avoided in initial feasibility measurements. The substrate was left in pretreatment solution for 1 or 2 hours followed by copious treatment with chloroform 5 or 6 times, followed by water rinse and dried in air. The octadecyltrichlorosilanes can be purchased from Aldrich. This chemical is moisture sensitive and needs to be prepared fresh daily due to presence of moisture in atmosphere. This procedure will lead to the surface hydrophobic that can lead to ease in separation of the master from the replica. Thickness of the layer deposited by this method is very thin, i.e., about 2-3 nm. The master with this SAM coating can be repeatedly used for multiple replication procedures.

Method B: The pretreatment solution was prepared by the following procedure. First, Dynasylan F 8261 (Degussa Huls) was adjusted to about 0.5-2 wt % upon dilution with ethanol or isopropanol. Thereafter, 2 wt % of distilled water was added which has to be adjusted with either Acetic acid or HCl to get to pH of 2-3. The solution was then stirred for a minimum of 5 hrs. This solution should be used within three days. The cleaned substrate was then dipped in the solution for 1-15 min. After that, the solution was rinsed in ethanol 5 or 6 times to remove excess solution from the surface. The surface was then left at room temperature for a couple of days or heated at 80-150° C. for a few hours. This procedure will lead to the surface oleophobic and can lead to ease in separation of the master from the replica. Thickness of the layer deposited by this method is very thin, i.e., about 2-3 nm. The master with this SAM coating can be repeatedly used for multiple replication procedures.

### Alternate Release Layer Application Methods

In addition to the above-described SAM layer deposition methods which deposit SAM layers directly on the master surfaces, alternate methods of the invention for applying release layers are further discussed herein. These methods also utilize SAM or SAM like molecules in certain ways, for example, in association with other materials or techniques.

Method C (Using SAMs and low adhesion metals): As mentioned above, the low adhesion metal such as gold and silver can be used as a release layer. The desired thickness of gold should be in the range of 50-100 nm, and otherwise it would be discontinuous. According to this method, In order to increase adhesion of gold layer to alumina master, the aluminum master is coated either with Chrominium, titanium or SAM with thiol end group (e.g., 3-mercaptoprophyl trimethoxysilane using the above-identified coating Method A). Also, in order to reduce adhesion of gold to replica surface (aluminum or UV cured cement), gold layer may be coated with alkanethiols before coating it with aluminum or Norland 61.

Method D (Using SAMs with wet etching): Master surface is coated with solution of SAM described above. However, the replica surface is prepared separately by coating glass substrate with epoxy and aluminum layer. Then, the master grating with surface patterns coated with SAM is stamped on the replica surface, leaving SAM molecules on the replica surface wherever it is touched by the master. After that, the replica surface is etched to give required diffraction grating patterns. This wet etching techniques used herein are known in the art. This method will work only for reflection gratings and has advantage over standard photolithographic process since it does not involve any light exposure.

Method E (Using SAMs and low pressure oils or liquids): Master surface is coated with solution of SAM such as described in association with the above-identified Method A and B before depositing low pressure oils, glycerin, mannitol or other conventional release layer thereon. As mentioned above, conventional release layers include low-pressure oils (such as silicone oil and vacuum oil), glycerin, and mannitol, etc. Low-Express pressure oils are typically hydrophobic in nature and therefore have poor adhesion for both master and replica surface. Thus, when the master is coated with SAM before depositing low-pressure oils such as silicone oil and vacuum oil, such oils may increase adhesion to the master. However, among release layers, glycerin and mannitol have strong adhesion to both master and replica. Thus, when the master is coated with SAM before depositing glycerin or mannitol, such layers may reduce adhesion to the master.

Method F (Using SAMs and hydrophobic polymers): Hydrophobic polymers such as PDMS (polydimethyl siloxane), Teflon or other fluorinated polymer in vapor phase can be deposited onto master. SiO₂ is preferably, but not necessarily, deposited on the master before depositing PDMS to increase adhesion to the master. Master surface is coated with solution of SAM described above before depositing Teflon or other fluorinated polymer to increase adhesion to the master.

Although preferred embodiments of the present invention have been described in detail herein above, it should be clearly understood that many variations and/or modifications of the basic inventive concepts herein taught, which may appear to those skilled in the art, will still fall within the spirit and scope of the present invention as defined in the appended claims and their equivalents.

What is claimed is:

1. A method of forming a replica of a diffraction grating from a master grating, the method comprising the steps of:
depositing a release layer including a self-assembled monolayer on an upper surface of the master diffraction grating;
depositing a reflective layer over the release layer;
providing an adhesive layer and a substrate over the reflective layer; and
separating the substrate, the adhesive layer, and the reflective layer from the master diffraction grating, thereby producing a replica of diffraction grating.

2. The method of claim 1 further including the step of cleaning the master grating prior to the deposition of reflective layer over the release layer.

3. The method of claim 1 further including the step of curing the adhesive layer prior to the separating step.

4. The method of claim 1, wherein the self-assembled monolayer includes a functional group having high affinity for the upper surface of the master grating.

5. The method of claim 4, wherein the self-assembled monolayer has low affinity for the reflective layer deposited thereon.

6. The method of claim 1, wherein the self-assembled monolayer includes a functional group having low affinity for the upper surface of the master grating.

7. The method of claim 6, wherein the self-assembled monolayer has high affinity for the reflective layer deposited thereon.

8. The method of claim 1, wherein the self-assembled monolayer includes alkane phosphonic acids molecules.

9. The method of claim 1, wherein the self-assembled monolayer includes alkyl silane molecules.

10. The method of claim 1, wherein the self-assembled monolayer includes fluoro alkyl silane molecules.

11. The method of claim 1, wherein the self-assembled monolayer includes alkane carboxylic acids molecules.

12. The method of claim 1, wherein the self-assembled monolayer includes octadecyltrichlorosilanes monolayer.

13. The method of claim 1, wherein the self-assembled monolayer includes alkyl trichlorosilanes monolayer.

14. The method of claim 1, wherein the reflective layer includes aluminum.

15. The method of claim 14, wherein the adhesive layer includes epoxy.

16. The method of claim 14, wherein the adhesive layer includes UV curable cement.

17. The method of claim 1, wherein the reflective layer includes MgF₂ layer.

18. The method of claim 1, wherein the release layer has a thickness less than about five (5) nanometer.

19. The method of claim 1 further including the step of depositing, in association with the self-assembled monolayer, gold or silver layer over the upper surface of the master grating.

20. The method of claim 1 further including the step of depositing, in association with the self-assembled monolayer, a layer including materials selected from the group consisting low-pressure oil, glycerin, mannitol, carnauba wax, and debutyphthalate.

21. The method of claim 1 further including the step of depositing, in association with the self-assembled monolayer, hydrophobic polymers.

22. The method of claim 21, wherein the hydrophobic polymers include polydimethyl siloxane, Teflon or fluorinated polymer.

23. A method of forming a replica of a diffraction grating from a master grating, the method comprising the steps of:
providing a master having a patterned surface;
coating a self-assembled monolayer on the patterned surface of the master;
providing a replica blank including a substrate, adhesive layer and a reflective layer;
stamping the replica blank with the patterned surface of the master, thereby transferring the self-assembled monolayer of the master to the replica blank;
producing a diffraction grating replica by etching the replica blank having the self-assembled monolayer attached thereto.

24. A method of providing a plurality of diffraction grating replicas from a master grating, the method comprising the steps of:
(a) providing a master grating having a reflective upper surface;
(b) depositing a release layer including self-assembled monolayer on the upper surface of the master grating;
(c) depositing a reflective layer over the release layer;
(d) providing an adhesive layer and a substrate over the reflective layer;
(e) separating the substrate, the adhesive layer, and the reflective layer from the master grating; and
(f) repeating the steps (c) to (e) and thereby providing a plurality of diffraction grating replicas using the master grating.
